(19) United States
(12) Patent Application Publication
(10) Pub. No.: US 2026/0146652 A1
(43) Pub. Date: May 28, 2026

(54) TORQUE TRANSMISSION DEVICE, ASSEMBLY METHOD AND MOTOR VEHICLE SEAT

(71) Applicant: Faurecia Sièges d’Automobile, Nanterre (FR)

(72) Inventors: Johan TIREL, La Selle la Forge (FR); Damien GRIMAUD, CALIGNY (FR); Antoine VIGUIER, FLERS (FR)

(21) Appl. No.: 19/400,836

(22) Filed: Nov. 25, 2025

(30) Foreign Application Priority Data
Nov. 25, 2024 (FR) FR 24 12909

(51) Int. Cl. F16D 1/104; B60N 2/02; B60N 2/06; B60N 2/22; F16D 1/10

(52) U.S. Cl. CPC F16D 1/104; B60N 2/0224; B60N 2/067; B60N 2/22; F16D 2001/103; F16D 2250/0084

(57) ABSTRACT

A torque transmission device that includes: a hub rotatable about an axis of rotation, the hub having an orifice delimited by an inner surface bearing axial hub splines distributed circumferentially around the axis of rotation; and a shaft having a shaft end portion delimited by an outer surface bearing shaft splines, the shaft splines cooperating with the hub splines to transmit torque. The shaft end portion is intended to be inserted into the orifice through an open axial end of said orifice. Each hub spline terminates toward the open axial end in a point and two chamfers arranged on either side of the point.

### TECHNICAL FIELD

The invention relates in general to a torque transmission device, intended in particular for installation in a motor vehicle seat.

### BACKGROUND

Such a torque transmission device may comprise:
a hub rotatable about an axis of rotation, the hub having an orifice delimited by an inner surface bearing axial hub splines distributed circumferentially around the axis of rotation;
a shaft having a shaft end portion delimited by an outer surface bearing shaft splines, the shaft splines cooperating with the hub splines to transmit torque.

When the torque transmission device is mounted, the shaft end portion is introduced into the orifice through an open axial end of said orifice.

When the insertion operation is carried out on an automated production line, the device may be damaged. Damage can occur when the shaft splines are misaligned with the hub splines. In particular, when the hub splines are in line with the shaft splines, engaging the shaft end portion into the hub can lead to damage to either of the two parts, or to jamming that makes assembly impossible.

### SUMMARY

In this context, the invention aims to propose a torque transmission device that does not have this defect.

To this end, the invention relates to a torque transmission device comprising:
a hub rotatable about an axis of rotation, the hub having an orifice delimited by an inner surface bearing axial hub splines distributed circumferentially around the axis of rotation;
a shaft having a shaft end portion delimited by an outer surface bearing shaft splines, the shaft splines cooperating with the hub splines to transmit torque,
the shaft end portion being intended to be inserted into the orifice through an open axial end of said orifice;
each hub spline terminates toward the open axial end in a point and two chamfers arranged on either side of the point.

As each hub spline ends in a point and two chamfers arranged on either side of the point, the likelihood of the device being damaged when the shaft end portion engages the rotating hub is considerably reduced. At the same time, there is no risk of jamming during insertion, thus avoiding any disruption to the assembly phase.

Normally, the shaft splines each engage between two hub splines. If the shaft splines are substantially aligned with the hub splines when they are inserted into the orifice, the shaft splines come to bear against the chamfers formed at the ends of the hub splines. These chamfers will circumferentially deflect the shaft end portion and guide the shaft splines so that they each engage between two hub splines.

The torque transmission device may furthermore comprise one or more of the following features, considered alone or according to any technically possible combinations:
each hub spline has two lateral flanks facing circumferentially towards two adjacent hub splines, the two chamfers connecting the two lateral flanks to the point;
each chamfer has a normal that forms an angle of between 30°and 80°with the axis of rotation;
first and second hub splines are provided to ensure pre-orientation of the shaft end portion at the moment of insertion into the orifice, the first and second hub splines being located on portions of the inner surface opposite each other with respect to the axis of rotation, the tips of the first and second hub splines being offset towards the open axial end with respect to the tips of the other hub splines, the tips of the first hub spline and the other hub splines being angularly evenly spaced around the axis of rotation, the second hub spline being located between two other hub splines, the point of the second hub spline being angularly relatively closer to the point of one of said two other hub splines than to the point of the other of said two other hub splines;
the point of the first hub spline is axially relatively closer to the open axial end than the point of the second hub spline;
the hub comprises a flexible lug which biases the shaft end portion towards the first hub spline at the moment when it is inserted into the orifice.
each shaft spline terminates towards one end of the shaft in a shaft point and two shaft chamfers arranged on either side of the shaft point.

According to a second aspect, the invention relates to a motor vehicle seat comprising a squab, a backrest pivoting relative to the squab and at least one torque transmission device having the above features connecting the squab to the backrest.

According to a third aspect, the invention relates to a motor vehicle seat comprising:
a squab;
at least one rail attached to a floor of the motor vehicle;
for the or each rail, a slide integral with the squab and moveable along said rail; and
a mechanism for driving the or each slide in translation along the corresponding rail;
the drive mechanism comprising:
   a motor;
   for the or each slide, a torque transmission device having the above characteristics, the hub of said torque transmission device being rotated by the motor,
   for the or each torque transmission device, a device for converting the rotational movement of the shaft into a translational movement of the slide along the rail.

According to a fourth aspect, the invention relates to a method of assembling a torque transmission device having the above features, comprising engaging the shaft end portion in the hub orifice through the open axial end of said orifice, the shaft splines being received between the hub splines.

### BRIEF DESCRIPTION OF THE DRAWINGS

Other features and advantages of the invention will become apparent from the detailed description given hereunder, by way of non-limiting indication, referring to the appended figures, among which:

FIG. 1 is a perspective view of a torque transmission device according to a first embodiment of the invention, with a partial section of the shaft and hub;

FIG. 2 is a perspective view of the hub of the torque transmission device of FIG. 1;

FIG. 3 is a front view of the hub of FIG. 2;

FIGS. 4 and 5 are perspective views of the hub and shaft for a second embodiment of the torque transmission device of the invention;

FIG. 6 is an axial sectional view of a variant of the torque transmission device shown in FIGS. 4 and 5;

FIG. 7 is a schematic front view of the hub shown in FIG. 6, with the shaft ribs superimposed in a potentially problematic situation;

FIG. 8 is a partial representation of a first motor vehicle seat implementing the torque transmission device of the invention; and

FIG. 9 is a partial perspective view of another motor vehicle seat implementing the torque transmission device of the invention.

### DETAILED DESCRIPTION

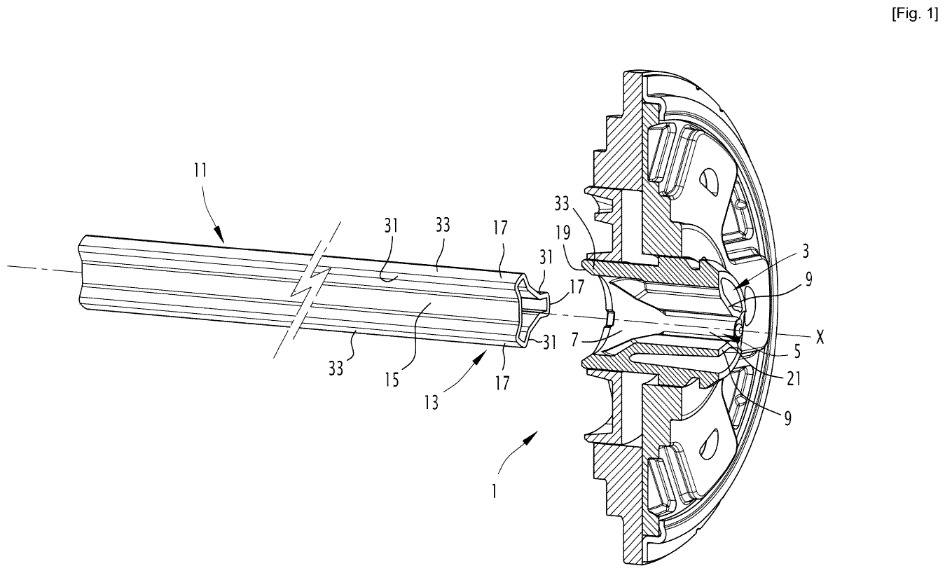

The device 1 shown in FIG. 1 is a torque transmission device for use, among other things, in motor vehicle seats.

The torque transmission device 1 comprises:
a hub 3 rotatable about an axis of rotation X, the hub 3 having an orifice 5 delimited by an inner surface 7 bearing axial hub splines 9 distributed circumferentially around the axis of rotation X;
a shaft 11 having a shaft end portion 13 delimited by an outer surface 15 bearing shaft splines 17, the shaft splines 17 cooperating with the hub splines 9 to transmit torque.

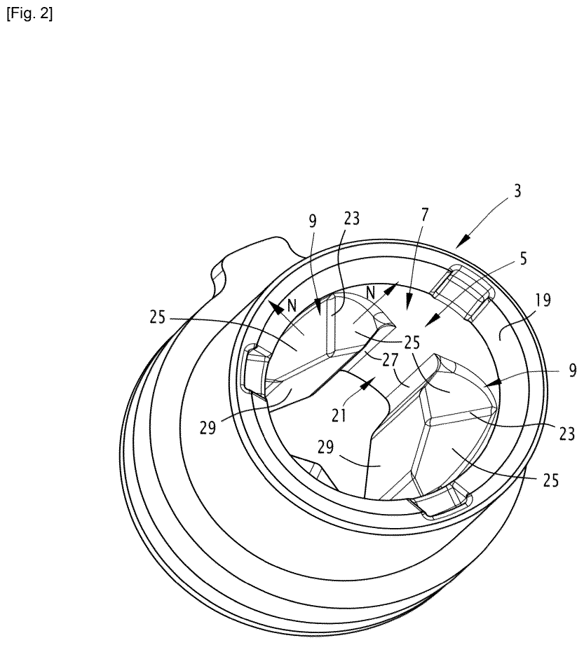

The shaft end portion 13 is designed to be introduced into the orifice 5 through an open axial end 19 of said orifice (FIG. 2).

The shaft splines 17 fit into grooves 21, each defined between two hub splines 9.

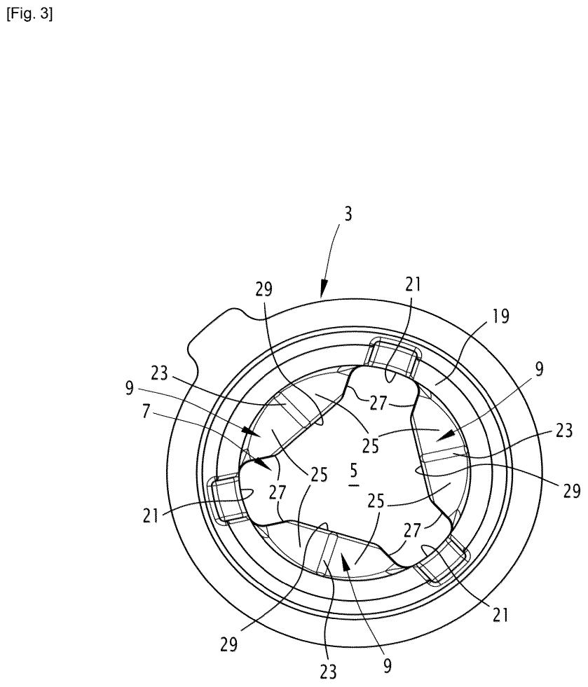

The inner surface 7 of the orifice 5 is cylindrical, as shown in FIG. 3. Perpendicular to the axis of rotation X, this inner surface 7 is circular.

In the example shown, the hub 3 comprises three hub splines 9. Alternatively, it features more than three hub splines 9, for example four, five or more hub splines 9.

The inner surface 5 is slightly flared at the open axial end 19, to facilitate insertion of the shaft end portion 13.

In the example shown, the shaft 11 is hollow, and the outer surface 15 is polygonal in shape.

The shaft end portion 13 has a number of shaft splines 17 equal to the number of hub splines 9.

The hub splines 9 are evenly distributed circumferentially around the axis of rotation X. They are all identical to one another.

Similarly, the shaft splines 17 are evenly distributed circumferentially around the axis of rotation X. They are all identical to one another.

The hub splines 9 are straight and parallel to each other.

Similarly, the shaft splines 17 are straight and parallel to each other.

Each hub spline 9 terminates toward the open axial end 19 in a point 23 and two chamfers 25 arranged on either side of the point 23.

As shown in FIG. 3, each hub spline 9 has two lateral flanks 27 facing circumferentially towards two adjacent hub splines 9. Each groove 21 is thus delimited by two lateral flanks 27, belonging to the two hub splines 9 adjoining the groove 21.

In the example shown, each flank 27 extends the full length of the hub spline 9. Each flank 27 is connected to the inner surface 7 along an axial line. The flanks 27 are substantially perpendicular to the inner surface 7 along the connection line.

Each hub spline 9 is also delimited towards the axis of rotation X by an intermediate face 29. The intermediate face 29 extends the full length of the hub spline 9. It connects the two flanks 27 to each other, and is located between the two flanks 27.

The two chamfers 25 connect the two lateral flanks 27 to the point 23.

The point 23 corresponds to the edge along which the two chamfers 25 meet. This edge extends substantially in a plane containing the axis of rotation X. The edge starts from the intermediate face 29 and extends radially therefrom towards the inner surface 7 and axially towards the open axial end 19, as far as the inner surface 7. The ridge extends in a radial median plane of the hub spline 9.

Each chamfer 25 is delimited radially on one side by the inner surface 7, and on the other side by the intermediate face 29. Circumferentially, it is delimited on one side by the edge forming the point 23, and on the other side by the flank 27.

When the chamfer 25 is followed from the edge forming the point 23 to the flank 27, the axial distance from the open axial end 19 is reduced

Each chamfer 25 has a normal N forming an angle of between 30 and 80° with the axis of rotation X. This angle is preferably between 50 and 75°, for example 70° (FIG. 2). This angle is chosen according to the angular and radial error between the shaft and hub.

The shaft splines 17 have cross-sections designed to fit into the grooves 21. In cross-section in a plane perpendicular to the axis of rotation X, they each have a cross-section complementary to that of the groove 21.

Each shaft spline 17 is delimited by two flanks 31 joined together by a top surface 33.

The top surfaces 33 are arched and shaped to bear against the area of the inner surface 7 forming the bottom of the grooves 21.

The flanks 31 have orientations adapted to bear against the flanks 27 of the hub splines 9.

The assembly of the torque transmission device 1 is carried out by engaging the shaft end portion 13 in the hub orifice 5 through the open end 19 of said orifice.

The shaft splines 17 fit between the hub splines 9

If the shaft splines 17 are not axially aligned with the grooves 21 delimited between the hub splines 9, each shaft spline 17 comes to bear against a chamfer 25 of one of the hub splines 9. Due to the orientation of the chamfer 25, the shaft spline 17 is guided towards one of the grooves 21. The shaft end portion 13 then undergoes both axial and circumferential movement, leading it to engage correctly in the grooves 21 separating the hub splines 9.

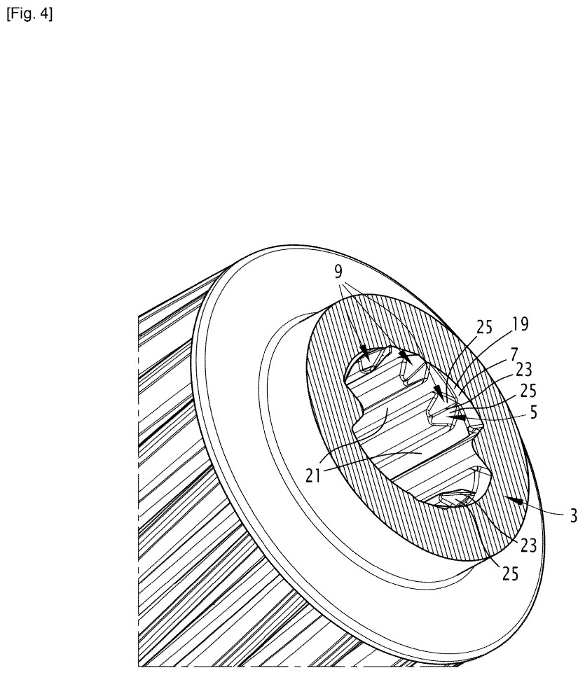

A second embodiment of the invention will now be described with reference to FIGS. 4 to 7.

Only the points in which this second embodiment differs from the first will be detailed below. Elements that are identical or provide the same functions will be designated by the same reference signs in both embodiments.

In the second embodiment, the hub 3 comprises a large number of hub splines 9. In the example shown, the hub 3 comprises ten hub splines 9. Alternatively, it has fewer or more than ten hub splines 9.

Similarly, the shaft 11 has a large number of shaft splines 17. This number of shaft splines is equal to the number of hub splines.

According to a first aspect of the second embodiment, each shaft spline 17 terminates towards one end 35 of the shaft in a shaft point 37 and two shaft chamfers 39 arranged on either side of the shaft point 37.

The end 35 of the shaft has a generally conical shape, and ends in a flat nose 41.

The tips 37 of the shaft splines 17 converge towards the nose 41.

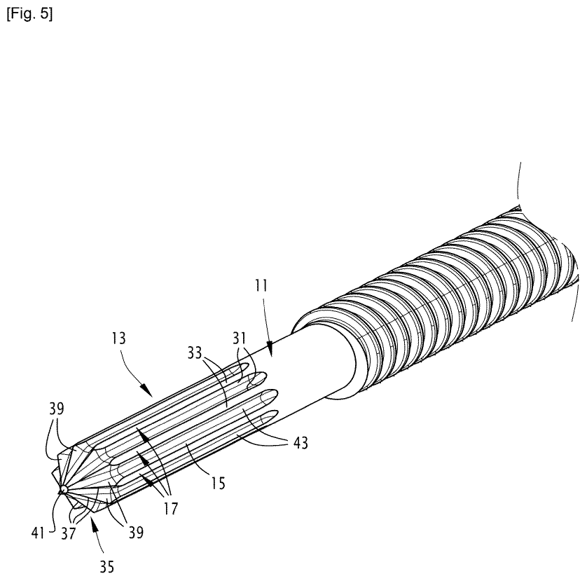

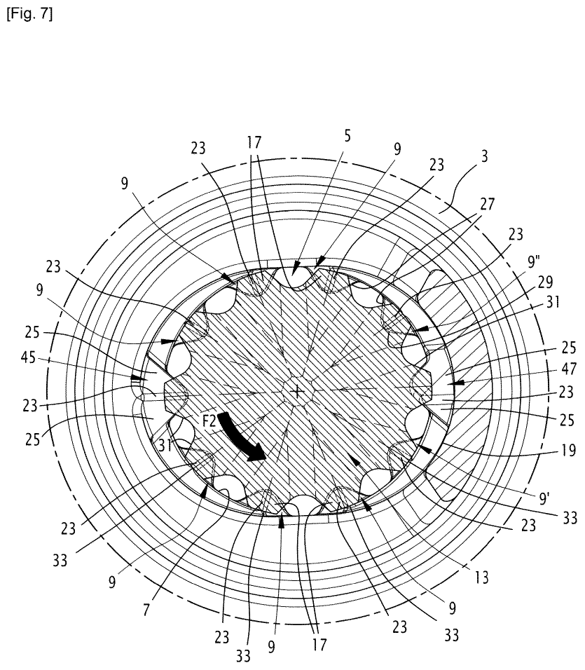

More precisely, and as shown in FIGS. 5 and 7, each shaft spline 17 is delimited by two shaft flanks 31 facing adjacent splines, and a top surface 33 connecting the two shaft flanks 31 to each other.

Each shaft point 37 extends axially from the top surface 33 to the nose 41. The shaft chamfers 39 are positioned circumferentially on either side of the shaft point 37. The shaft point 37 forms the joining edge of the two shaft chamfers 39.

The shaft splines 17 define a plurality of shaft grooves 43 between them. Each shaft chamfer 39 extends axially between the nose 41 and one of the flanks 31 of the shaft spline 17. Circumferentially, it extends between the point 37 of the shaft spline and the bottom of the shaft groove 43 on the same side.

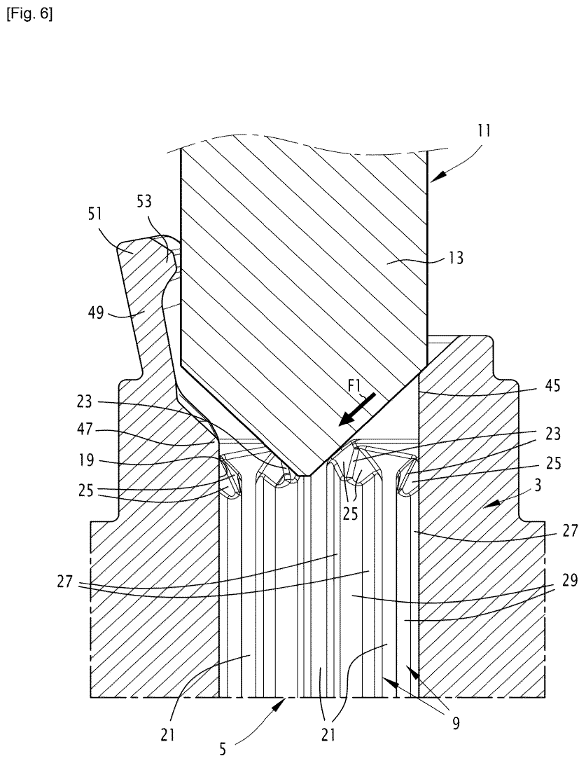

According to a second aspect, shown in FIGS. 6 and 7, first and second hub splines 45 and 47 are provided to ensure pre-orientation of the shaft end portion 13 upon insertion into the orifice 5.

The first and second hub splines 45, 47 are located on opposite parts of the inner surface 7 with respect to the axis of rotation X.

When the hub 5 has an even number of hub splines 9, the first and second hub splines 45, 47 are advantageously diametrically opposed, as shown in FIG. 7.

As can be seen in FIG. 6, the tips 23 of the first and second hub splines 45, 47 are offset towards the open axial end 19 of the orifice 5 with respect to the tips 23 of the other hub splines 9.

In other words, the first and second hub splines 45, 47 extend further than the other hub splines 9 towards the open axial end 19.

As a result, when the shaft end portion 13 is inserted into the orifice 5, this shaft end portion 13 will first encounter the first and second hub splines 45, 47, before encountering the other hub splines 9.

The point 23 of the first hub spline 45 is axially relatively closer to the open axial end 19 than the point 23 of the second hub spline 47.

As shown in FIG. 7, the hub splines 9, including the first and second hub splines 45, 47, are circumferentially evenly distributed around the axis of rotation X.

The tips 23 of the first hub spline 45 and the other hub splines 9 are angularly evenly spaced around the axis of rotation X.

The second hub spline 47 is located between two of the other hub splines 9, referenced 9′ and 9″ in FIG. 7.

The point 23 of the second hub spline 47 is angularly relatively closer to the point 23 of the hub spline 9′ than to the point 23 of the hub spline 9″.

In other words, the point 23 of the second hub spline 47 is circumferentially offset towards the point of one of the adjacent hub splines, and relatively further away from the point of the other of the two adjacent hub splines.

In the example shown in FIG. 7, where the first hub spline 45 and the second hub spline 47 are diametrically opposed, the point 23 of the second hub spline 47 does not face the point 23 of the first hub spline 45.

As a result, the second hub spline 47 has two chamfers 25 of unequal size. One chamfer 25 is relatively smaller and the other chamfer 25 is relatively larger.

The circumferential chamfer on the hub spline 9′ side is smaller and the circumferential chamfer on the hub spline 9″ side is larger. The point 23 of the second hub spline 47 is not located in the median axial plane of the second hub spline 47. It is offset circumferentially to one side of this plane.

In contrast, for the first hub spline 45 and all the other hub splines 9, the point 23 is located in the median axial plane of the corresponding spline.

Furthermore, as can be seen in FIG. 6, the hub 5 comprises a flexible lug 49 which biases the shaft end portion 13 towards the first hub groove 45 when the shaft end portion 13 is inserted into the orifice 5.

The flexible lug 49 extends axially from an edge of the open axial end 19. At its free end 51, it carries a bead 53. When projected in the plane of the open axial end 19, that is when projected along the axial direction in a plane perpendicular to the axial direction, the bead 53 projects inwards from the open axial end 19.

The flexible lug 49 is located opposite the first hub groove 45 in relation to the axis of rotation X.

It is flexible in the sense that it can be deformed radially, outwards from the orifice 5, as shown in FIG. 6.

The pre-orientation function of the shaft end portion 13 will now be described in detail.

As the shaft end portion 13 is inserted into the orifice 5, the shaft end portion 13 is moved axially towards the open axial end 19. The shaft end portion 13 is deflected by the flexible lug 49 radially towards the first hub spline 45.

The shaft end portion 13 comes into contact with the bead 53, causing the shaft end portion 13 to move radially.

The shaft end portion 13 then continues its axial movement, abutting the end of the first hub spline 45.

If the shaft splines 17 are circumferentially offset from the hub splines 9, the first hub spline 45 will circumferentially deflect one of the shaft splines 17 so that it engages one of the grooves 21. The other shaft splines 17 will engage in the other grooves 21.

The contact between the first hub spline 45 and the shaft spline 17 that comes into contact with it produces both a circumferential movement of the shaft end portion 13 and a radial movement towards the center of the orifice 5.

When the shaft end portion 13 continues its movement, the axis of the shaft end portion 13 is aligned with the axis of the orifice 5, and the flexible lug 49 is deformed by bending outwards from the orifice 5.

In the case where the shaft end portion 13 is presented in front of the open axial end 19 with an orientation wherein the shaft splines 17 are perfectly aligned with the hub splines 9, as shown in FIG. 7, contact between the first hub spline 45 and the shaft spline 17 coming into contact with it will not produce any circumferential deviation. This contact will cause an axial and radial movement, as shown by arrow F1 in FIG. 6, forcing the shaft end portion 13 into contact with the second hub spline 47.

When the axial movement of the shaft end portion 13 towards the interior of the orifice 5 is prolonged, due to the circumferential offset of the point 23 of the second hub spline 47 towards the hub spline 9′, one of the shaft splines 17 will come into contact with the larger-surface chamfer 25 of the second hub spline 47. The shaft end portion 13 is then deflected circumferentially as shown by arrow F2 in FIG. 7. The shaft spline 17 in contact with the larger-area chamfer 25 will be guided by this chamfer to engage in the groove 21 located between the second hub spline 47 and the shaft spline 9″. The other shaft splines 17 will then be suitably oriented to engage in the other grooves 21 of hub 3.

The radial deflection of the shaft end portion 13 towards the second hub groove 47 will cause the lug 49 to bend outwards from the orifice, as shown in FIG. 6.

When the number of hub splines 9 is odd, the second hub spline 47 is not arranged diametrically opposite the first hub spline 45. It is offset circumferentially by half a step from the position shown in FIG. 7. A pitch corresponds to the circumferential distance between two hub splines 9. Its shape is similar to that shown in FIG. 7: the point 23 is offset towards the adjacent 9′groove. It has two chamfers 25 of different sizes, the chamfer 25 facing the 9′ groove being smaller and the chamfer 25 facing the 9″ groove being larger.

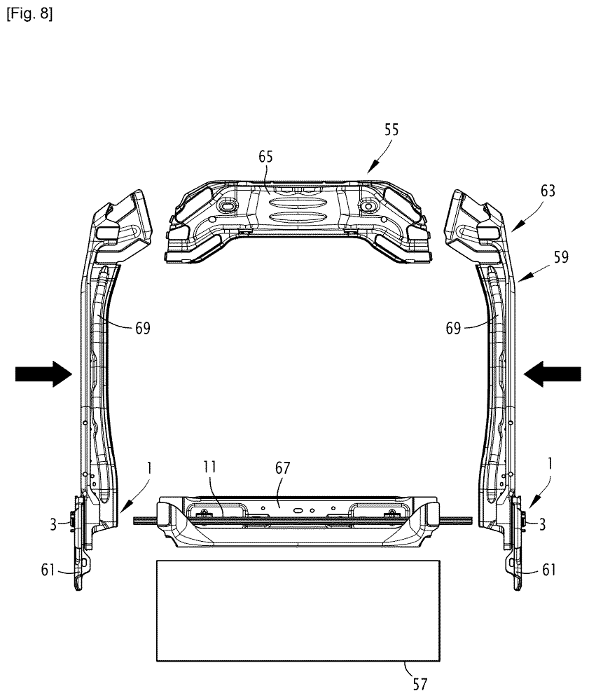

A first example of a motor vehicle seat using the torque transmission device 1 described above is shown in FIG. 8.

The seat 55 comprises a squab 57, a backrest 59 and at least one torque transmission device 1 connecting the squab 57 to the backrest 59.

In the example shown, the seat 55 has two torque transmission devices 1, each connecting the squab 57 to the backrest 59. Alternatively, the seat 55 comprises only one torque transmission device 1.

The shaft 11 is common to both torque transmission devices 1. However, the hubs 3 are separate.

The or each torque transmission device 1 forms a swivel joint by which the backrest 59 is connected to the squab 57.

The hub 3 of each torque transmission device 1 is mounted on a plate 61 designed to be rigidly attached to the squab 57. The two plates 61 are transversely spaced apart and transversely facing each other.

The backrest 59 comprises a frame 63 with an upper cross-member 65, a lower cross-member 67 and two lateral uprights 69.

The end portions 13 of the shaft 11 are engaged in the orifices 5 of the hubs 3 when the frame 63 is assembled.

As shown in FIG. 8, prior to assembly, the shaft 11 is attached to the lower cross-member 67. The plates 61 are connected to the two lateral uprights 69.

The frame 63 is assembled by moving the lateral uprights 69 transversely with respect to the lower cross-member 67, and typically also with respect to the upper cross-member 65. The lateral uprights 69 are moved in opposite directions, as shown in FIG. 8.

This movement causes the shaft end sections 13 to engage in the hubs 3 supported by the plates 61. They also enable the lateral uprights 69 to be correctly positioned in relation to the lower and upper cross-members 65, 67.

After this transverse movement, causing the shaft end portions 13 to engage in the orifices 5, the frame components are secured to one another.

Finally, the plates 61 are rigidly attached to the squab 57.

The frame 63 can be assembled automatically, that is, by a robot. As a result, engagement of the shaft end sections 13 in the hubs 3 is also carried out automatically, without operator intervention. Due to the design of the torque transmission devices 1, engagement of the shaft end portions 13 in the orifices 5 is carried out with an extremely low failure rate. This engagement can take place even if the shaft splines 17 are initially substantially aligned transversely with the hub splines 9.

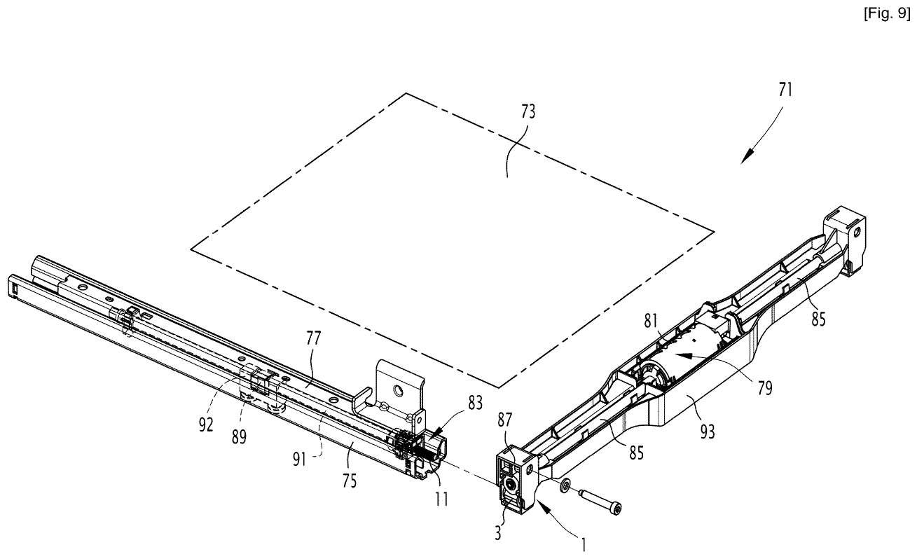

A further example of a motor vehicle seat using the torque transmission device 1 described above is shown in FIG. 9.

The seat 71 comprises:
a squab 73;
at least one rail 75 attached to the floor of the motor vehicle;
for the or each rail, a slide 77 integral with the seat and movable along said rail 75; and
a mechanism 79 for translating the or each slide 77 along the corresponding rail 75.

The locking mechanism 79 comprises:
a motor 81; and
for the or each slide 77, a torque transmission device 1 as described above, the hub 3 of said torque transmission device 1 being rotated by the motor 81.

The drive mechanism 79 also includes, for the or each torque transmission device 1, a device 83 for converting the rotational movement of the shaft 11 into a translational movement of the slide 77 along the rail 75.

Typically, the seat 71 comprises two parallel rails 75. It further comprises two slide rails 77, two torque transmission devices 1 and two conversion devices 83. Only a rail, a slide and a torque transmission device are shown in FIG. 9.

The motor 81 comprises two output shafts 85, each bearing a pinion 87 designed to cooperate with the hub 3 of one of the two torque transmission devices 1. The axis of rotation of hub 3 is perpendicular to output shaft 85, but runs parallel to the corresponding rail 75. The hub 3 has an external helical thread, cooperating with the pinion 87. The hub 3 works like a worm screw.

In the example shown, the conversion device 83 is of the screw-nut type. In other words, it comprises a nut 89 cooperating with a screw 91 integral with shaft 11. The nut 89 comprises a thread which is complementary to that of the screw 91. The nut 89 is locked in a nut support 92. The nut support 92 is rigidly attached to the rail 75. The screw 91 is fixed in longitudinal translation relative to the slide 77 and free to rotate relative to the slide 77. The hub 3 rotates the shaft 11 and screw 91, causing the screw 91 to move axially relative to the nut 89 and the slide 77 relative to the rail 75.

The motor 81 and output shafts 85 are housed in a transverse cradle 93, integral with the squab 73. The hubs 3 are mounted at the two opposite transverse ends of the cradle 93. The rails 75 are longitudinally oriented.

The torque transmission device disclosed hereinbefore has multiple advantages.

The fact that each hub spline has two lateral flanks facing circumferentially towards two adjacent hub splines, with the two chamfers connecting the two lateral flanks to the point, means that the shaft splines are adequately guided by the two chamfers when the shaft end portion engages in the open axial end of the orifice. The chamfers deflect the shaft splines into the grooves on either side of the hub splines.

The fact that each chamfer has a normal that forms an angle of between 30° and 80° with the axis of rotation contributes to the precision of guidance to the corresponding groove.

The first and second hub splines allow the shaft end portion to be pre-oriented on insertion into the orifice, irrespective of the circumferential orientation of the shaft splines relative to the hub splines. Even if the shaft splines are strictly aligned with the hub splines when the shaft end portion enters the orifice, the arrangement of the first and second hub splines allows the shaft splines to be correctly oriented so that they engage in the grooves defined between the hub splines.

The flexible lug urging the shaft end portion towards the first hub spline at the moment when it is inserted into the orifice helps to ensure that the shaft end portion will contact the first hub spline first, making it easier and more reliable to insert the shaft end portion into the orifice.

The fact that the point of the first hub spline is axially relatively closer to the open axial end of the orifice than the point of the second hub spline helps to make insertion of the shaft end portion into the orifice easier and therefore more reliable.

The fact that each shaft spline terminates towards one end of the shaft in a shaft point and two shaft chamfers arranged on either side of the shaft point helps to make insertion of the shaft end portion into the orifice easier and more reliable.

1. A torque transmission device, comprising:
a hub rotatable about an axis of rotation, the hub having an orifice delimited by an inner surface bearing axial hub splines distributed circumferentially about the axis of rotation; and
a shaft having a shaft end portion delimited by an outer surface bearing shaft splines, the shaft splines cooperating with the hub splines to transmit torque,
the shaft end portion being adapted to be introduced into the orifice through an open axial end of said orifice;
each hub spline terminating toward the open axial end in a point and two chamfers arranged on either side of the point.

2. The torque transmission device according to claim 1, wherein each hub spline has two lateral flanks facing circumferentially towards two adjacent hub splines, the two chamfers connecting the two lateral flanks to the point.

3. The torque transmission device according to claim 2, wherein each chamfer has a normal forming an angle of between 30° and 80° with the axis of rotation.

4. The torque transmission device according to claim 1, wherein first and second hub splines are provided to ensure pre-orientation of the shaft end portion at the moment of insertion into the orifice, the first and second hub splines being located on portions of the inner surface opposite each other with respect to the axis of rotation, the tips of the first and second hub splines being offset towards the open axial end with respect to the tips of the other hub splines, the tips of the first hub spline and the other hub splines being angularly evenly spaced around the axis of rotation, the second hub spline being located between two other hub splines, the point of the second hub spline being angularly relatively closer to the point of one of said two other hub splines than to the point of the other of said two other hub splines.

5. The torque transmission device according to claim 4, wherein the point of the first hub spline is axially relatively closer to the open axial end than the point of the second hub spline.

6. The torque transmission device according to claim 4, wherein the hub comprises a flexible lug biasing the shaft end portion toward the first hub spline at the moment when it is inserted into the orifice.

7. The torque transmission device according to claim 1, wherein each shaft spline terminates towards one end of the shaft in a shaft point and two shaft chamfers arranged on either side of the shaft point.

8. A motor vehicle seat comprising a squab, a backrest pivotable relative to the squab and at least one torque transmission device according to claim 1 connecting the squab to the backrest.

9. A seat for a motor vehicle comprising:
a squab;
at least one rail attached to a floor of the motor vehicle;
for the or each rail, a slide integral with the squab and moveable along said rail; and
a mechanism for driving the or each slide in translation along the corresponding rail;
the drive mechanism comprising:
a motor;
for the or each slide, a torque transmission device according to claim 1, the hub of said torque transmission device being rotated by the motor;
for the or each torque transmission device, a device for converting the rotational movement of the shaft of said torque transmission device into a translational movement of the corresponding slide along the rail.

10. A method of assembling a torque transmission device according to claim 1, comprising engaging the shaft end portion in the orifice of the hub through the open axial end of said orifice, the shaft splines being received between the hub splines.
